(19) United States
(12) Patent Application Publication
(10) Pub. No.: US 2016/0049731 A1
(43) Pub. Date: Feb. 18, 2016

(54) ANTENNA DEVICE

(71) Applicant: TEIJIN LIMITED, Osaka (JP)

(72) Inventors: Machiko YAMAMOTO, Ibaraki-shi (JP); Naoya ASAMURA, Tokyo (JP)

(73) Assignee: TEIJIN LIMITED, Osaka-shi, Osaka (JP)

(21) Appl. No.: 14/782,179

(22) PCT Filed: Apr. 7, 2014
(86) PCT No.: PCT/JP2014/060075

§ 371 Date: Oct. 2, 2015

(30) Foreign Application Priority Data
Apr. 5, 2013 (JP) 2013-080016

(51) Int. Cl. H01Q 9/04; H02J 7/02; H02J 5/00

(52) U.S. Cl. CPC H01Q 9/045; H02J 5/005; H02J 7/025

(57) ABSTRACT

An antenna device is equipped with a power supply part (21) and a communication part (31). The power supply part (21) is equipped with a first active electrode (23) and a first passive electrode (25), and a high frequency voltage is applied between the first active electrode (23) and first passive electrode (25) by a high frequency generator (27). The communication part (31) is equipped with a line part (33), which is electromagnetically coupled with an external device and connected at one end to a power supply point, and a terminal resistor (35) connected to the other end of the line part (33). A signal terminal of a communication device (37) is connected to the power supply point, and the ground terminal of the communication device (37) is connected to the terminal resistor. The antenna device has an overall sheet-like shape.

### TECHNICAL FIELD

The present disclosure relates to an antenna device equipped with a power supply function and a communication function.

### BACKGROUND ART

Information processing terminals, that is, portable terminals, are used that are equipped with a wireless phone function and a WiFi function.

Frequently this type of information processing terminal operates by using an internal secondary battery.

Charging of the secondary battery is typically performed by connecting terminals of the portable terminal to terminals of a charger. This charging method has problems such as complexity of the connecting-disconnecting of the connection terminals, occurrence of failed connections, and exposure of the terminals, which is unsuitable for an electronic device that requires waterproofing.

Technology is used that solves such problems by the wireless supplying and receiving of electrical power.

For example, Patent Literature 1 discloses a method for electrical power supply using electrostatic induction. According to this electrical power supply method, a power supply device is equipped with an active electrode for generation of a strong electrical field and a passive electrode for generation of a weak electrical field. The electrical power receiver is equipped with an active electrode disposed in the region in which the strong electrical field is formed and a passive electrode disposed in the region in which the weak electrical field is formed. Due to this configuration, a potential difference is generated between the active electrode and passive electrode of the electrical power receiver, and electrical power is supplied from the power supplier to the power receiver.

### CITATION LIST

### Patent Literature

Patent Literature 1: International Publication No. WO2007/107642

### SUMMARY OF INVENTION

### Technical Problem

An antenna device equipped with a power supply function and a communication function, in addition to an active electrode and a passive electrode for the supply of electrical power, is required to have an antenna for communication. Thus arrangement and handling of the active electrode, passive electrode, and communication antenna is difficult. Furthermore, the antenna device becomes large-sized.

In consideration of the aforementioned circumstances, an object of the present disclosure is to provide a miniaturized and easily handled antenna device that is equipped with a communication function and a power supply function.

### SOLUTION TO PROBLEM

The antenna device of the present disclosure is sheet-shaped and includes: a line part configured to connect at one end to a signal terminal of a communication device to communicate with an external device, a first active electrode, and a first passive electrode configured to receive a high frequency voltage applied between the first active electrode and the first passive electrode.

For example, the line part is spiral-shaped, one of a central end and a peripheral end of the spiral pattern is configured to connect to a terminal resistor part, and the other end is configured to connect to a power supply part.

For example, the line part includes a conductive mesh, the power supply part connected to a certain position of the conductive mesh, and the terminal resistor part is connected to another position of the conductive mesh.

For example, the line part is the first active electrode, or the line part is the first passive electrode.

For example, the first active electrode or the first passive electrode is disposed at a periphery of the line part.

The line part can be disposed between the first active electrode and the first passive electrode.

For example, at least one of the first active electrode and the first passive electrode is laminated to the line part, the line part includes lines disposed spaced apart at a pitch, and wavelength of an output signal of the high frequency voltage is larger than the pitch of the lines.

The external device, for example, further includes: a second active electrode configured to capacitively couple with the first active electrode; a second passive electrode configured to capacitively couple with the first passive electrode, the second passive electrode being larger than the second active electrode; and a load circuit configured to connect to the second active electrode and the second passive electrode, and to operate using a voltage induced between the second active electrode and the second passive electrode.

The antenna device, for example, may be mounted on a roof, pillar, center console, or interior panel of a mobile vehicle.

### ADVANTAGEOUS EFFECTS OF INVENTION

According to the present disclosure, the antenna used for communication and the antenna used for supplying power, that is, active electrode and passive electrode, are sheet-like. Thus a miniaturized and easily handled antenna device can be provided.

### BRIEF DESCRIPTION OF DRAWINGS

FIG. 1 is a structural view of an antenna device of a first embodiment of the present disclosure;

FIGS. 2A-2C shows drawings for explanation of physical structure of the combined-function communication-power supply sheet illustrated in FIG. 1, in which FIG. 2A is a top view, FIG. 2B is a cross-sectional view at the I-I line of FIG. 2A, and FIG. 2C is a bottom view;

FIG. 3 is a drawing for explanation of mutual communication with, and power supply to, an external device from the antenna device illustrated in FIG. 1;

FIG. 4 is a drawing for explanation of a modified example of physical structure of the combined-function communication-power supply sheet illustrated in FIGS. 2A-2C;

FIG. 5 is a drawing for explanation of another modified example of physical structure of the combined-function communication-power supply sheet illustrated in FIGS. 2A-2C;

FIGS. 6A-6C show respective modified examples of structure of the line part;

FIGS. 7A-7C show drawings for explanation of arrangement of the line part at the periphery of the active electrode and the passive electrode, in which FIG. 7A is a top view, FIG. 7B is a cross-sectional view illustrating a first example of cross-sectional structure at the II-II line of FIG. 7A, and FIG. 7C is a cross-sectional view illustrating a second example of cross-sectional structure at the II-II line of FIG. 7A;

FIGS. 8A-8C show drawings for explanation of arrangement of the line part between the active electrode and the passive electrode, in which FIG. 8A is a top view, FIG. 8B is a cross-sectional view illustrating a first example of cross-sectional structure at the III-III line of FIG. 8A, and FIG. 8C is a cross-sectional view illustrating a second example of cross-sectional structure at the III-III line of FIG. 8A;

FIGS. 9A-9C show drawings for explanation of stacked-layered arrangement of the line part and the active electrode and passive electrode, in which FIG. 9A is a top view, FIG. 9B is a cross-sectional view at the IV-IV line of FIG. 9A, and FIG. 9C shows wiring;

FIGS. 10A and 10B show drawings for explanation of the antenna device that has a structure combining the line part and the active electrode, in which FIG. 10A is a circuit diagram, and FIG. 10B is a top view of the combined-function communication-power supply sheet;

FIG. 11 is an explanatory drawing of the antenna device that has a structure combining the line part and the passive electrode; and

FIG. 12 is a drawing for explanation of an example in which the antenna device according to an(the) embodiment is arranged at various portions of an automobile.

### DESCRIPTION OF EMBODIMENTS

Antenna device of embodiments of the present disclosure are explained below while referring to figures.

The antenna devices of the below described embodiments are each formed from a combined-function communication-power supply sheet.

The antenna device is equipped with a function for performing communication with an external device such as a portable terminal or an RF tag and a function for performing power-supply by supplying electrical power to an external device, and the antenna device is formed from a sheet-like combined-function communication-power supply sheet.

### Embodiment 1

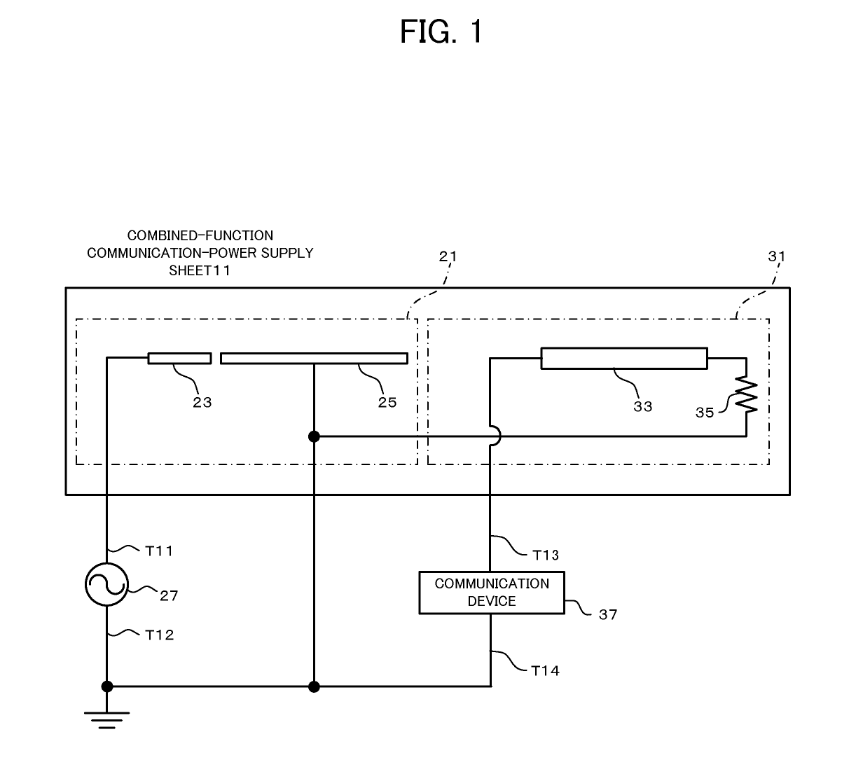

A combined-function communication-power supply sheet 11, that is, antenna device, of the present embodiment, as illustrated in FIG. 1, is a sheet-like device that has a power supply part 21 for supply of power to an external device by capacitive coupling and electrostatic induction, and has a communication part 31 for electrostatic inductive or electromagnetic inductive signal exchange by capacitive coupling or electromagnetic inductive coupling with the external device.

The power supply part 21 is equipped with a first active electrode 23 and a first passive electrode 25 and is connected to a high frequency-high voltage generator 27.

In order to supply electrical power to the external device, the first active electrode 23 (that is, active electrode, power supply electrode, and power supply antenna) is composed of a thin film conductor to allow capacitive coupling, that is, electrostatic inductive coupling, with a second active electrode arranged on the external device.

In order to supply power to the external device, the first passive electrode 25 (that is, passive electrode, power supply electrode, and power supply antenna) is composed, for example, of a thin film conductor to capacitively couple, that is, electrostatically-capacitively couples, with a second passive electrode arranged on the external device. The first passive electrode 25 is formed to have a larger surface area than the first active electrode 23. Moreover, the first active electrode 23 and the first passive electrode 25, for example, are arranged so as to avoid mutual overlap.

For supply of power to another device, the high frequency-high voltage generator 27 generates a high frequency high voltage, such as an AC voltage of several tens of volts to several thousand volts at a frequency of several KHz to 100 GHz, between a first terminal T11 and a second terminal T12. The first terminal T11 is connected to the first active electrode 23, and the second terminal T12 is connected through the ground to the first passive electrode 25.

On the other hand, the communication part 31 is connected to a communication device 37 and is equipped with a line part 33 and a terminal resistor 35.

The line part 33 functions as the communication antenna. The line part 33 is composed of a conductor line, that is, microstrip line, that has a resonance point in the frequency band that includes a signal transmission frequency fs and a signal reception frequency fr, and that electromagnetically couples (e.g. capacitively couples, electromagnetically-inductively couples and the like) with the communication antenna of the external device. Length L of the conductor line of the line part 33 is preferably set, for example, to an integer multiple of one half the central wavelength λ of the frequency band that includes the frequencies fs and fr.

To adjust the impedance between a grounding terminal T14 of the communication device 37 and one end of the line part 33, the terminal resistor 35 connects to the other end of the line part 33 for grounding.

The communication device 37 has a signal terminal T13 and a grounding terminal T14, the signal terminal T13 is connected to one end of the line part 33, and the grounding terminal T14 is grounded.

The input impedance Zi as seen from the signal terminal T13 and the grounding terminal T14 of the communication device 37, the characteristic impendence Z0 of the line part 33, and the impedance Zr of the terminal resistor 35 are set so as to be equal to one another, as indicated by the following equation.

Zi=Z0=Zr

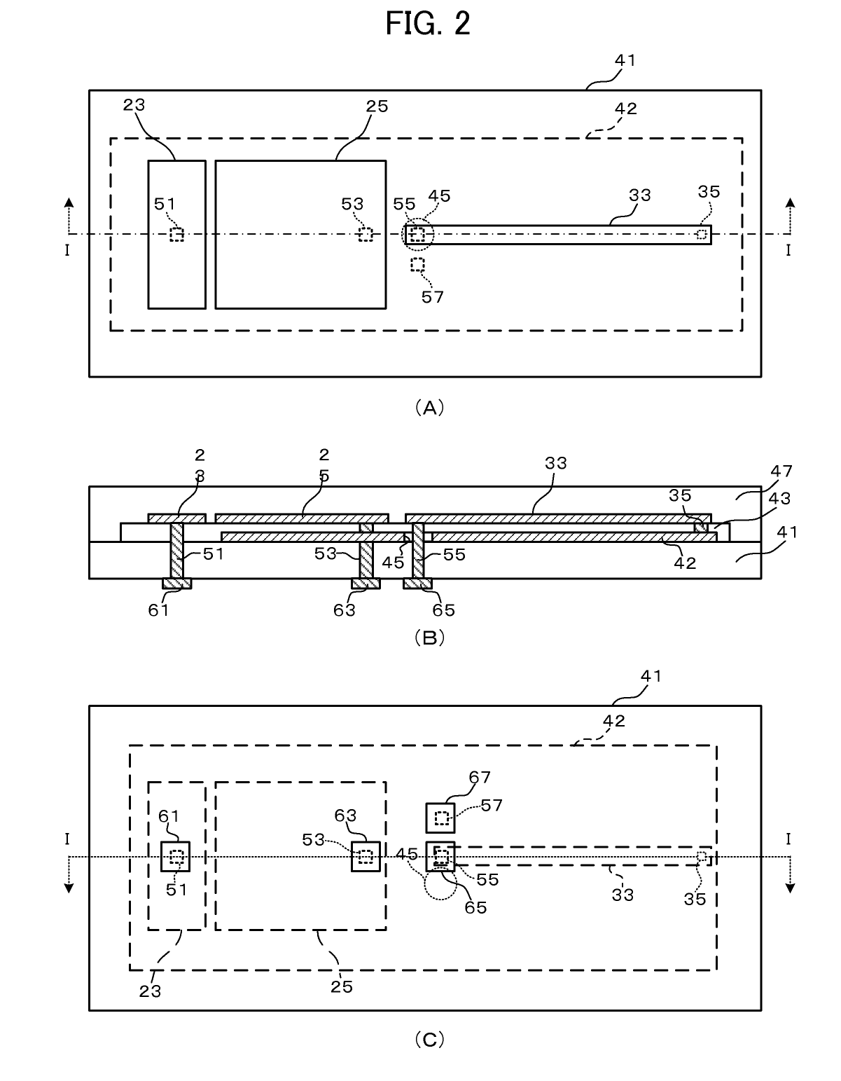

The structure of the aforementioned combined-function communication-power supply sheet 11 is explained in reference to FIGS. 2A-2C.

FIG. 2A is a top view of the combined-function communication-power supply sheet 11 illustrated in FIG. 1, FIG. 2B is a cross-sectional view at the I-I line, and FIG. 2C is a bottom view. Furthermore, the top view shows appearance after removal of an uppermost protective layer 47.

Firstly, an insulating substrate 41 is prepared. A rigid substrate or a flexible substrate can be used as the insulating substrate 41.

The insulating substrate 41 is composed of a flat plate-like dielectric sheet. The specific dielectric constant of the insulating substrate 41 at 800 MHz to 10 GHz frequency is 1.0 to 15, preferably is 1.0 to 5.0, and further preferably is 1.0 to 3.0.

A resin sheet can be used as the sheet forming the insulating substrate 41. Materials for forming this resin sheet and that satisfy the aforementioned specific dielectric constant include resins such as olefin resins (TPO), styrene resins (SBC), polyvinyl chloride resins (TPVC), urethane resins (PU), ester resins (TPE), amide resins (TPAE), fluorinated resins (PTFE), epoxy resins, phenol resins and polyphenylene ether resins. In consideration of specific dielectric constant and processing ability, preferred materials are polyolefins such as polyethylene (PE) and polypropylene (PP); polyesters such as polyethylene terephthalate (PET), polyethylene naphthalate (PEN), polybutylene terephthalate (PBT), and polytrimethylene terephthalate (PTT); and polyimide (PI), and polyesters and polyolefins are particularly preferred materials.

The aforementioned resin sheet preferably is a porous material. Examples that can be cited of the porous material include foamed polyethylene and foamed polypropylene having a porosity of 50 to 85%. Due to use of a porous material as the sheet, porosity increases and the specific dielectric constant approaches 1, and thus stable communication performance can be obtained. As long as the resin sheet is porous, the resin sheet material can be an opened-cell foam or a closed-cell foam.

The utilized sheet constituting the insulating substrate 41 can have a fibrous structure such as that of a woven fabric, knitted fabric, wet-laid non-woven fabric, or dry-laid non-woven fabric. When the sheet has a fibrous structure, the fineness of one filament is preferably from 0.5 to 30 dtex, and more preferably is from 0.5 to 10 dtex. Moreover, when the sheet is made from the woven fabric or knitted fabric, a multifilament yarn is preferably used in which the total fineness is preferably 30 to 1,500 dtex, and more preferably is 30 to 800 dtex. Furthermore, when the sheet is made from the woven fabric, the woven fabric density is preferably from 15 to 200 yarns/inch, and more preferably is from 15 to 150 yarns/inch, these woven fabric densities indicating both warp density and weft density. The warp density and the weft density can be the same or different.

Examples of materials that can be used to form the aforementioned fibrous structure include: polyesters such as polyethylene terephthalate (PET), polyethylene naphthalate (PEN), polybutylene terephthalate (PBT) and polytrimethylene terephthalate (PTT); aliphatic polyamides such as nylon 6, nylon 66 and nylon 12; aromatic polyamides such as polyparaphenylene terephthalamide and polymethaphenylene terephthalamide; and polypropylene (PP), polyethylene (PE), polycarbonate (PC), polyimide (PI) and glass.

Moreover, an elastic sheet can be used as the sheet constituting the insulating substrate 41. Examples of sheets having elastic properties that can be used include synthetic rubber sheets such as sheets of chloroprene rubber (CR), butyl rubber (IIR), nitrile rubber (NBR), ethylene/propylene rubber (EPM/EPDM), natural rubber (NR), urethane rubber, fluorine-contained rubber and silicone rubber. Examples of sheets having elastic properties that can be used also include elastomer fiber structures, such as woven fabrics, knitted fabrics and non-woven fabrics using elastomer fibers, and a non-woven fabric having a high porosity is particularly preferred. Among such elastomer fiber structures, the use of elastomer fiber structures having elastomer fibers of 0.1 μm to 20 μm is preferred. Flexibility and bending fatigue resistance are excellent when an elastomer fiber structure or an elastic synthetic rubber sheet is used.

When a fiber structure is used for the sheet constituting the insulating substrate 41, examples of cross-sectional shapes of the fibers forming the fiber structure can include, in addition to a circular shape, variant cross-sectional fiber shapes such as hollow-shaped, C-shaped, H-shaped, I-shaped, L-shaped, T-shaped, cross-shaped, Y-shaped, triangle-shaped, square-shaped and flat-shaped. Moreover, the utilized fiber can be a composite crimped fiber that has a side-by-side type or eccentric core sheath type cross section, a fiber that develops crimps by anisotropic cooling during spinning, a fiber mechanically provided with crimps, and the like. By use of such fiber, the porosity of the base material can be increased, transmission efficiency can be increased, and communication performance can be improved.

When the sheet used for the insulating substrate 41 has a fiber structure, such as that of a wet-laid non-woven fabric (including paper), dry-laid non-woven fabric, or woven fabric, and if a paste of a conductor is printed on the base material surface in order to form wiring as described below, the surface of the fiber structure is preferably coated with a resin, or the fiber structure is preferably hardened by resin impregnation. The example materials cited for use in the aforementioned resin sheet can be used as this coating-impregnating resin.

Thickness of the insulating substrate 41 is preferably 0.2 to 10 mm, and further preferably is 0.5 to 2.0 mm. Moreover, basis weight of the base material is preferably 50 to 800 g/m², and more preferably is 80 to 300 g/m².

On the upper surface of the insulating substrate 41, the ground line 42 is formed for common grounding of the power supply part 21 and the communication part 31.

Electrical resistance of the conductor forming the ground line 42 is preferably less than or equal to 5 ohms per square, and further preferably is 0.0001 to 1 ohms per square. Thus the material used as the conductor forming the ground line 42 preferably includes gold, silver, copper, aluminum, nickel or stainless steel. The ground line 42 is formed through processes including: printing of conductor paste; plating, vapor deposition, or lamination of the conductor; and further patterning of the printed conductor paste. A thick metal film can be produced by plating or laminating using a material including a metal such as copper, silver, aluminum, nickel and the like. Furthermore, thickness of the metal film is preferably 0.00001 to 50 μm, and more preferably is 1 to 25 μm.

As illustrated in FIG. 2B, an insulating film 43 is formed covering the ground line 42. The insulating film 43, for example, has the same composition as the insulating substrate 41.

The first active electrode 23 and the first passive electrode 25 are arranged adjacent to one another on the insulating film 43. The first active electrode 23 extends to the back surface of the insulating substrate 41 through a via 51 formed in the insulating substrate 41 and the insulating film 43. A pad 61 connected to the via 51 is arranged on the back surface of the insulating substrate 41. The pad 61 connects to one terminal T11 of a high frequency-high voltage generator 27.

The first passive electrode 25 is formed with a surface area larger than that of the first active electrode 23 and is connected to the ground line 42 through a via 53 formed in the insulating substrate 41 and insulating film 43. The via 53 further extends to the back surface of the insulating substrate 41. A pad 63 connected to the via 53 is arranged on the back surface of the insulating substrate 41. The other terminal T12, that is, ground terminal, of the high frequency-high voltage generator 27 is connected to the pad 63.

On the other hand, a line part 33 is formed on the insulating film 43. The formed line part 33, for example, has a width of 1.0 to 6.0 mm and a thickness of 1 to 25 μm.

One tip portion of the line part 33 extends to the back surface of the insulating substrate 41 through a via 55 formed in the insulating substrate 41 and insulating film 43. A pad 65 connected to the via 55 is arranged on the back surface of the insulating substrate 41. Furthermore, an opening 45 is formed in the ground line 42 so that the ground line 42 and the via 55 do not touch one another.

Moreover, the terminal resistor 35 is arranged at a position corresponding to the tip portion of the line part 33 of the insulating film 43. The terminal register 35 connects the other tip portion of the line part 33 and (to) the ground line 42.

Furthermore, as illustrated in FIG. 2A, a via 57 connected to the ground line 42 is formed in the insulating substrate 41 at a position near the via 55. As illustrated in FIG. 2B, a pad 67 connected to the via 57 is arranged on the back surface of the insulating substrate 41.

The pads 65 and 67 function as power supply points, that is, power supplies, for the line part 33 functioning as a communication antenna. The signal terminal T13 of the communication device 37 is connected to the pad 65 by a connector such as a coaxial cable, and the grounding terminal T14 is connected to the pad 67 by a connector such as a coaxial cable.

As illustrated in FIG. 2B, an insulating protective layer 47 is formed covering the first active electrode 23, first passive electrode 25, line part 33, and the like.

In this manner, the combined-function communication-power supply sheet 11 is formed overall as a thin, single-sheet-like member, and pads 61, 63, 65 and 67 are arranged on the back surface for connection to the external device.

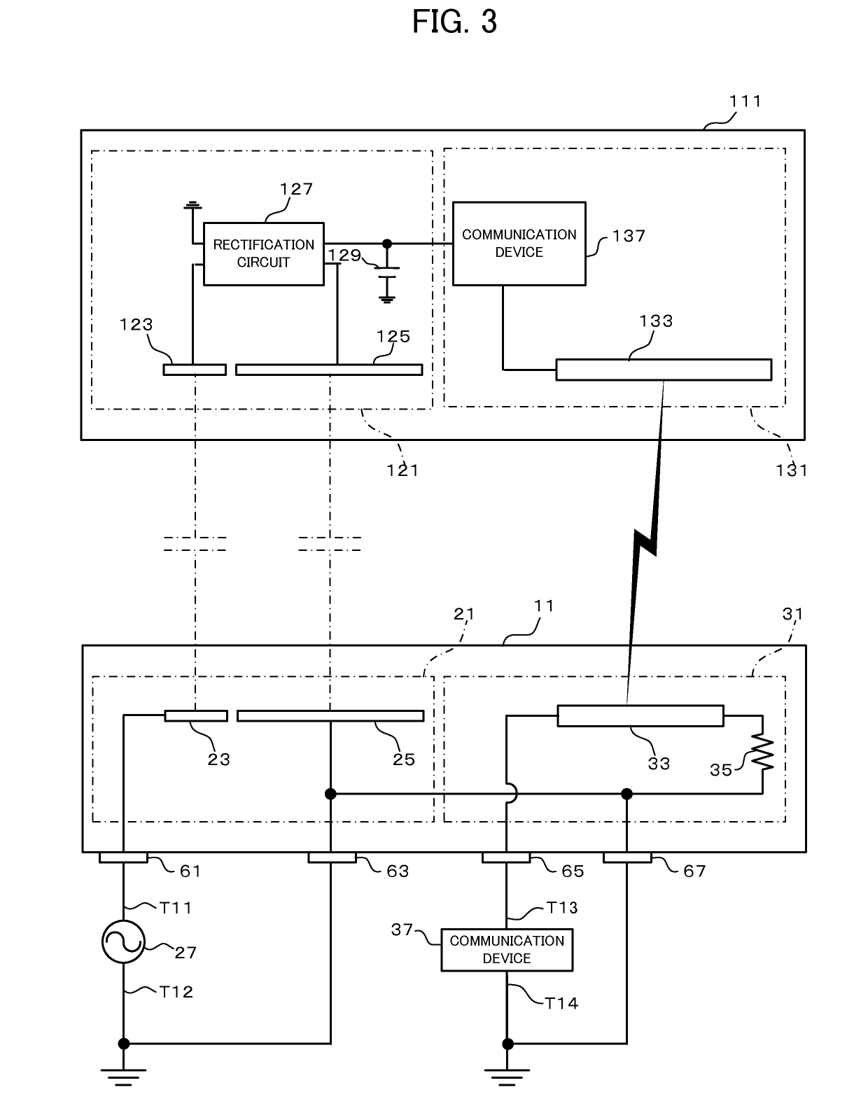

The operation of communication and supplying power to the external device 111 by the combined-function communication-power supply sheet 11 is explained next in reference to FIG. 3.

The external device 111, for example, is constituted by a device such as a portable communication terminal or RF tag and is equipped with a power receiver 121 and a communication part 131.

The power receiver 121 is a device that receives electrical power supplied via electrostatic induction from the combined-function communication-power supply sheet 11 and stores electrical power. The power receiver 121 is equipped with a second active electrode 123, a second passive electrode 125, a rectification circuit 127 and a secondary battery 129.

The second active electrode 123 faces the first active electrode 23 and electrostatically-inductively couples with the first active electrode 23. The second passive electrode 125 faces the first passive electrode 25 and electrostatically-inductively couples with the first passive electrode 25.

The rectification circuit 127 is connected to the second active electrode 123 and the second passive electrode 125, and performs voltage transformation and full-wave rectification of the alternating current obtained by electrostatic induction between the second active electrode 123 and the second passive electrode 125, and outputs the rectified voltage to the secondary battery 129.

The secondary battery 129 stores direct current electrical power supplied by the rectification circuit 127. The electrical power stored by the secondary battery 129 is supplied as driving power to an internal circuit of the external device 111, such as a communication part 131.

The communication part 131 is equipped with a communication antenna 133 and a communication device 137. The communication antenna 133 performs short-range wireless communication with the line part 33. The communication device 137 operates by using electrical power from the secondary battery 129 as a power source and communicates with the communication device 37 of the combined-function communication-power supply sheet 11 through the communication antenna 133.

The power supply operation is explained first. The high frequency-high voltage generator 27 of the combined-function communication-power supply sheet 11 applies a high frequency high voltage, such as one hundred and several tens of volts, between the first active electrode 23 and the first passive electrode 25. By application of this high frequency voltage, electrical fields are generated at each of the first active electrode 23 and the first passive electrode 25. However, the first active electrode 23 is smaller than the first passive electrode 25, and thus strength of the generated electrical field is greater for the first active electrode 23 than for the first passive electrode 25.

When the first active electrode 23 and the second active electrode 123 capacitively couple and the first passive electrode 25 and the second passive electrode 125 capacitively couple in this state, a high voltage at high frequency is induced in the second active electrode 123, and a low voltage at high frequency is induced in the second passive electrode 125. Thus an alternating current voltage occurs between the second active electrode 123 and the second passive electrode 125.

The rectification circuit 127 rectifies this alternating current voltage and charges the secondary battery 129.

The communication operation is explained next. The communication device 137 operates by using power supplied from the secondary battery 129, and during signal transmission, modulates the carrier wave signal using the transmission signal (baseband signal), and outputs the modulated carrier wave signal to the communication antennal 133. The communication antenna 133 emits the modulated carrier wave signal. The emitted radio wave is received by the line part 33 and is processed by the communication device 37. Moreover, the radio wave sent through the line part 33 by the communication device 37 is received by the communication antenna 133 and is processed by the communication device 137.

In this manner, the combined-function communication-power supply sheet 11 is capable of supply of power using electrostatic induction to the external device 111 as well as wireless communication with the external device 111.

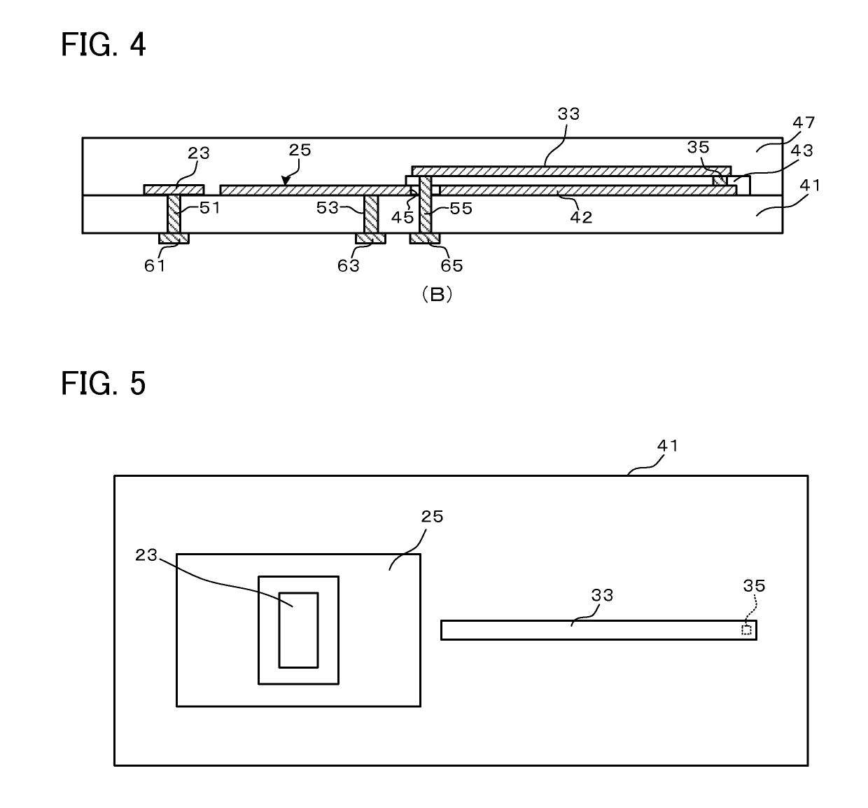

Furthermore, although the passive electrode 25 and the ground line 42 are separately arranged according to the configuration of FIGS. 2A-2C, for example, the passive electrode 25 and the ground line 42 can be integrally formed together as illustrated in FIG. 4. According to the configuration of FIG. 4, the entire ground line 42 functions as the passive electrode. Moreover, the active electrode 23 can be arranged upon the insulating substrate 41.

Moreover, a freely-selected layout may be used for the first active electrode 23 and first passive electrode 25, and for example, as illustrated in FIG. 5, a relatively large first passive electrode 25 can be arranged in a shape so as to surround a relatively small first active electrode 23.

Adoption of this type of configuration results in an electrical field arrangement in which the space region of strong electrical field is surrounded by a region of weak electrical field, and power becomes easily supplied to the other device.

Moreover, although the indicated example of the ground line 42 is formed from a single layer of conductive film, other shapes and configurations can be used.

Although in the above explanation the indicated power supply part 21 and communication part 31 are formed on the same insulating substrate, the power supply part 21 and the communication part 31 may be arranged on independent substrates, which are then connected and fixed together to form a single combined-function communication-power supply sheet 11.

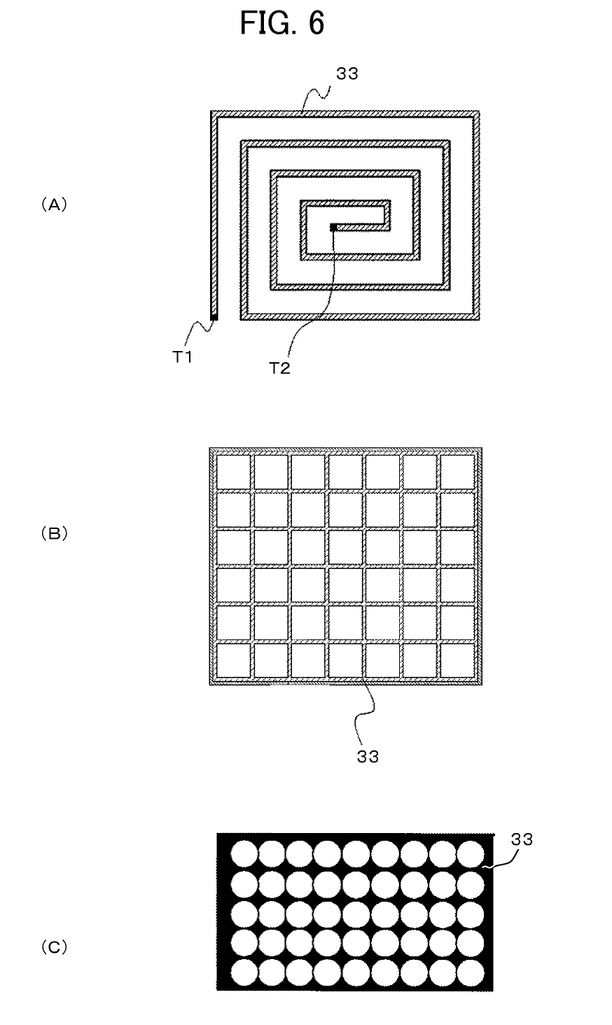

Although the line part 33 is explained above as having a linearly extending shape, any known freely-selected shape can also be used. Examples of shapes that can be used include any shape such as the spiral shape illustrated in FIG. 6A and the lattice or mesh shapes illustrated in FIG. 6B and FIG. 6C.

If a spiral-shaped line part 33 is used such as that illustrated in FIG. 6A, one terminal T1 or T2 is connected to the signal terminal T13 of the communication device 37, and the other terminal T2 or T1 is connected to ground through the terminal resistor 37.

If a mesh-shaped line part 33 is used such as that illustrated in FIG. 6B or FIG. 6C, the peripheral portion of the mesh is terminated at a pitch less than or equal to λ/2, and power is supplied to a single point somewhere in the interior portion. Modification is possible, such as arrangement of an absorber at the peripheral portion.

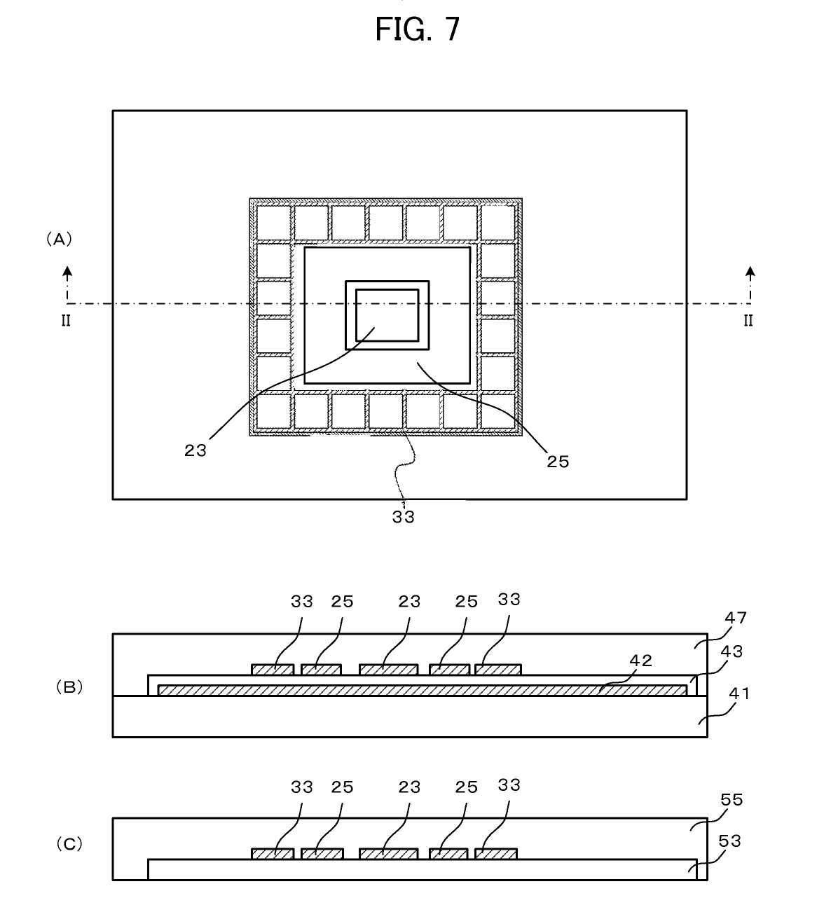

Moreover, the power supply antenna, that is, first active electrode 23 and first passive electrode 25, and the line part 33, that is, communication antenna, are not necessarily arranged adjacent to one another, but rather as indicated in FIGS. 7A-7C, the power supply part 21 and the communication part 31 can be integrated together by arrangement of the line part 33 surrounding a centrally arranged power supply antenna and the like. Conversely, the power supply antenna can be arranged surrounding a centrally arranged line part 33. Examples of cross-sectional structures in these cases are illustrated in FIGS. 7B and 7C. FIG. 7B shows an example configuration arranging a ground line 42 layer as a sublayer below the line part 33, and FIG. 7C shows an example configuration without such arrangement of a sublayer. In FIG. 7C, for example, the ground line 42 is arranged appropriately in a layer at the same level as that of the line part 33.

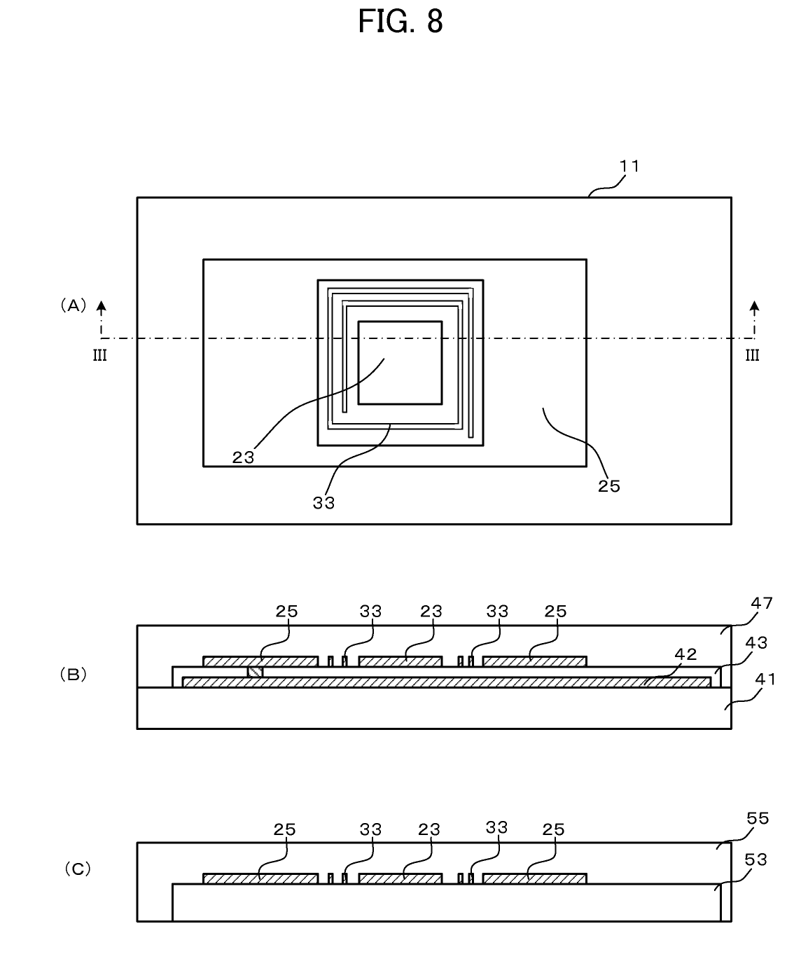

Moreover, as illustrated in FIG. 8A, integration of the power supply part 21 and the communication part 31 is also possible, for example, by arrangement of the line part 33 between the first active electrode 23 and the first passive electrode 25. Examples of the cross-sectional structure in this case are illustrated in FIGS. 8B and 8C. FIG. 8B shows an example of arrangement of the ground line layer 42 as a sublayer, and FIG. 8C shows an example without such arrangement of a sublayer. In FIG. 8C, for example, the ground line is arranged appropriately in a layer at the same level as that of the line part 33.

Furthermore, although an example is indicated in which input impedance Zi of the communication device 37, characteristic impedance Z0 of the line part 33, and impedance Zr of the terminal resistor 35 are set equivalent to one another, alternative settings are permissible. These values can be set appropriately as required for communication with the external device 111.

### Second Embodiment

Although the first active electrode 23 and the second passive electrode 25 are arranged adjacent to the line part 33, that is, communication antenna, in the aforementioned embodiment, stacked or overlapped arrangement is alternatively possible in order to effectively utilize surface area.

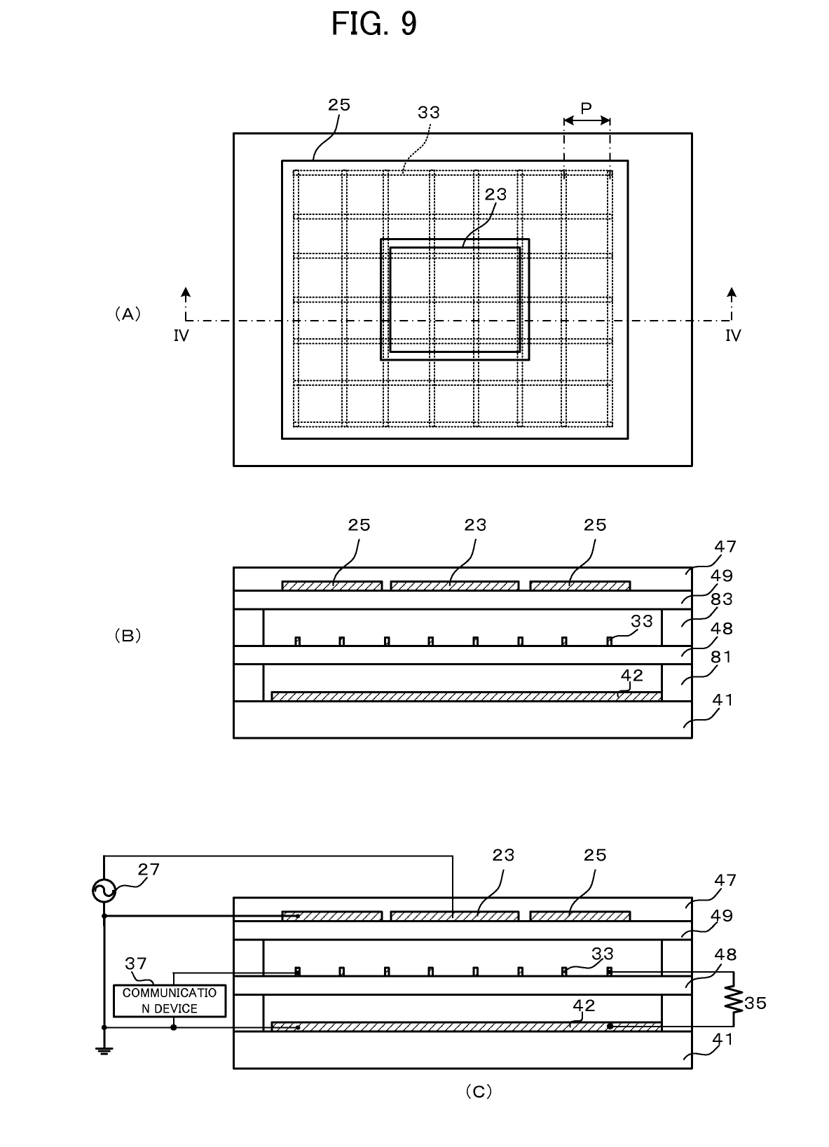

For example, in FIGS. 9A and 9B, a plate-like ground line 42 is arranged on a first layer insulating substrate 41, a spacer 81 is arranged between the first layer insulating substrate 41 and the second layer insulating substrate 48, on which is arranged a mesh-like line part 33, and a spacer 83 is further arranged between the second insulating substrate 48 and a third insulating substrate 49, on which are arranged an active electrode 23 and a passive electrode 25 surrounding the active electrode 23. The line part 33 is grounded by a non-illustrated terminal resistor.

Such grounding, for example, is indicated by the wiring illustrated in FIG. 9C.

The power supply operation of the line part 33 is unaffected if the pitch P of the mesh of the mesh-shaped line part 33 is smaller than the wavelength of the power supply electromagnetic field, and preferably is sufficiently smaller than the wavelength of the power supply electromagnetic field. Thus power supply and communication can both be realized by this type of configuration. Furthermore, the frequency of power transmission is lower than the frequency used for communication, that is, wavelength of power transmission is longer than the wavelength used for communication.

Furthermore, the shape of the line part 33 is not limited to a mesh shape, but rather a wide range of shapes can be used by appropriate arrangement at a pitch. Moreover, the entire line part 33 is not required to overlap the entire power supply electrodes 23 and 25, but rather partial overlapping is possible, such as when the line part 33 overlaps only the first active electrode 23, or when the line part 33 overlaps only the first passive electrode 25.

### Third Embodiment

Although the power supply electrodes 23 and 25 and the line part 33 are configured separately in the aforementioned first and second embodiments, the power supply electrodes and the communication antenna can be integrated together.

A configuration of the combined-function communication-power supply sheet 11 is explained below in which a power supply electrode and the communication antenna are integrated together.

Firstly, a configuration is described in which the first passive electrode 25 and the line part 33 are integrated together.

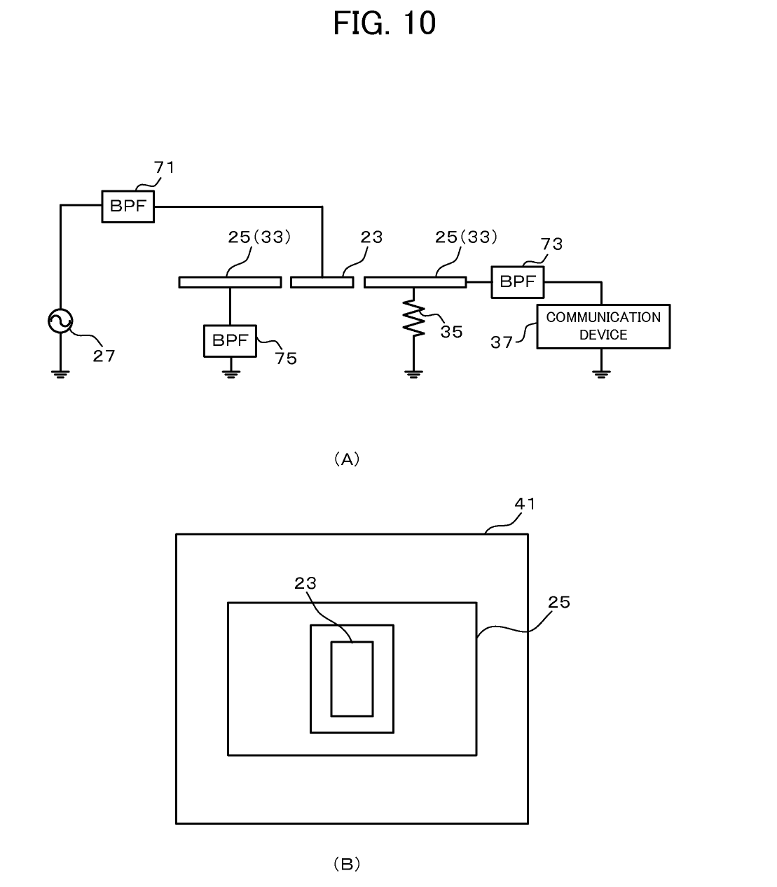

A circuit diagram of this integrated configuration is illustrated in FIG. 10A. Moreover, a top view of the combined-function communication-power supply sheet 11 is illustrated in FIG. 10B.

In this configuration, the first passive electrode 25, that is, line part 33, is connected at one end portion to the communication device 37, and another end portion is grounded through the terminal resistor 35.

The size and shape of the first passive electrode 25, for example, are set such that intrinsic impedance at the communication frequency matches the input impedance of the terminal resistor 35 and the communication circuit 37.

Moreover, in a circuit interconnecting one terminal of the high frequency-high voltage generator 27 and the other end portion, a bandpass filter BPF 71 is arranged to pass the high frequency used for power supply and cut off the frequency used for communication. Moreover, a bandpass filter BPF 75, for grounding the first passive electrode 25 and relating to the high frequency used for power supply, is arranged between the first passive electrode 25 and the ground terminal. Similarly, a bandpass filter BPF 73, for passing the communication signal and for cutting off the power supply frequency, is arranged in the circuit between the signal terminal T13 of the communication device 37 and the grounding terminal T13.

Furthermore, the arranged configuration of the first active electrode 23 and the first passive electrode 25 is not limited to the configurations illustrated in FIGS. 10A and 10B, and another freely-selected configuration can be used.

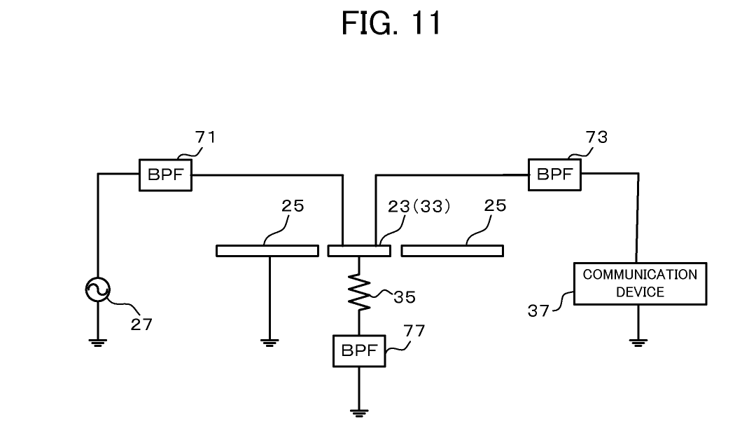

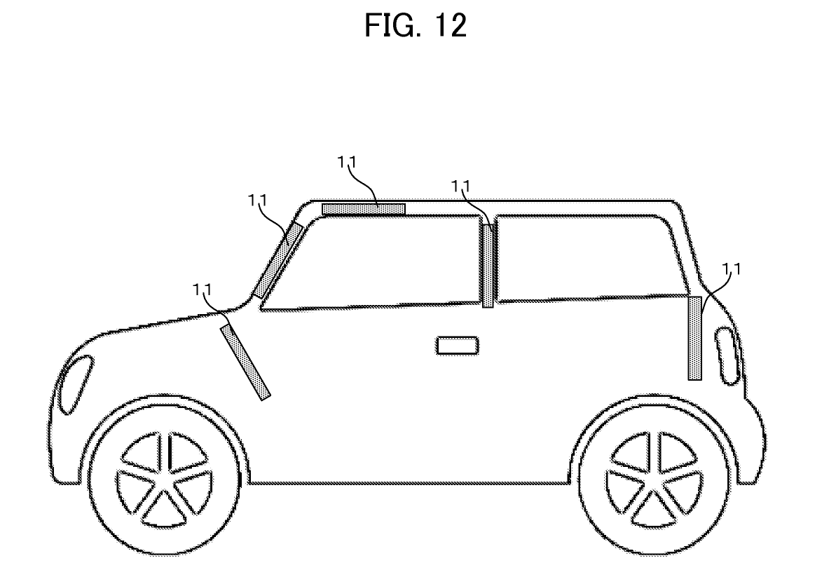

Moreover, the first active electrode 23 and the line part 33 can be combined. A circuit diagram of such a configuration is illustrated in FIG. 11. Moreover, FIG. 10B is equivalent to a top view of the combined-function communication-power supply sheet 11.

As illustrated, one end portion of the first active electrode 23, that is, the line part 33, is connected to the communication device 37, and another end portion is grounded through a terminal resistor 35 and a bandpass filter BPF 77. The bandpass filter BPF 77 passes the frequency signal used for communication and greatly attenuates signals of other frequencies, particularly the output frequency of the high frequency-high voltage generator 27.

The size and shape of the first passive electrode 25 are set such that intrinsic impedance Z0 at the communication frequency becomes equivalent to the impedance Zr of the terminal resistor 35 and the input impedance Zi of the communication device 37.

Moreover, a bandpass filter BPF 71, arranged in the circuit to interconnect one terminal of the high-frequency voltage generator 27 and the other end portion, passes the high frequency used for power supply and cuts off the frequency used for communication. In the same manner, a bandpass filter BPF 73, arranged in the circuit interconnecting the signal terminal T13 and the grounding terminal T13 of the communication device 37, passes the communication signal and cuts off the frequency used for power supply.

Furthermore, another type of filter, such as a low pass filter or a high pass filter, can be substituted for the bandpass filter as long as the same function is achieved.

Moreover, although the pads 63 and 67 are arranged as grounding terminals for external connection in the configuration of FIGS. 2A-2C, these pads can be combined. Furthermore, the physical layout, arrangement and the like can be appropriately modified.

Moreover, each of the insulation layers can be replaced by air, or alternatively, the air-filled parts, such as gaps, can be filled by an insulator.

As explained above, the embodiments of the present disclosure are capable of providing an antenna device capable of supplying power by electrostatic coupling with an external device such as an RF tag or a portable terminal, and the embodiment can also provide an antenna device capable of performing communication.

The antenna device of the above configuration is capable of being manufactured as a thin and elastic antenna device, and this antenna device can be installed in any location where a portable WiFi terminal is used and where an external device is used such as an RF tag. For example, if the antenna device is installed in the wall of a room, and if an external device is used within the room, then power can be supplied to the external device, and information can be exchanged.

Moreover, if the antenna device of the above configuration is disposed in a mobile object such as a vehicle, and if an external device is used within the vehicle, then power supply to the external device and communication with the external device are both possible. In this case, the sheet-like shape characteristic is used with advantage, for example, by attachment of the antenna device as illustrated in FIG. 12 to a roof, pillar, center console, interior panel and the like of the vehicle.

Furthermore, the present disclosure is not limited to the aforementioned embodiments, and various types of modifications and applications of the present disclosure are possible.

For example, the above mentioned numerical values, shapes, materials, layouts and the like are illustrative and are not limiting.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2013-080016, filed on Apr. 5, 2013, the entire disclosure of which is incorporated by reference herein.

### INDUSTRIAL APPLICABILITY

The present disclosure can be used to realize a miniaturized and easily handled antenna device equipped with a communication function and a power supply function.

### Reference Signs List

11 Combined-function communication-power supply sheet
21 Power supply part
23 First active electrode (active electrode, power supply electrode, power supply antenna)
25 First passive electrode (passive electrode, power supply electrode, power supply antenna)
27 High frequency-high voltage generator
31 Communication part
33 Line part (microstrip line, communication antenna)
35 Terminal resistor
37 Communication device
41, 48, 49 Insulating substrate
42 Ground line
43 Insulating film
45 Opening
47 Protective layer
51, 53, 55, 57 Via
61, 63, 65, 67 Pad
71, 73, 75, 77 Bandpass filter (BPF)
81, 83 Spacer
111 External device
121 Power receiver
123 Second active electrode
125 Second passive electrode
127 Rectification circuit
129 Secondary battery
131 Communication part
133 Communication antenna
137 Communication device

1. An antenna device, comprising:
a line part configured to connect at one end to a signal terminal of a communication device to communicate with an external device;
a first active electrode; and
a first passive electrode configured to receive a high frequency voltage applied between the first active electrode and the first passive electrode;
wherein shape of the antenna device is sheet-like.

2. The antenna device according to claim 1, wherein
the line part is spiral-shaped;
one of a central end and a peripheral end of the spiral shape is configured to connect to a terminal resistor part; and
the other end is configured to connect to a power supply part.

3. The antenna device according to claim 1, wherein
the line part comprises a conductive mesh;
the power supply part is connected to a certain position of the conductive mesh; and
the terminal resistor part is connected to another position of the conductive mesh.

4. The antenna device according to claim 1, wherein
the line part is the first active electrode, or the line part is the first passive electrode.

5. The antenna device according to claim 1, wherein
the first active electrode or the first passive electrode is disposed at a periphery of the line part.

6. The antenna device according to claim 1, wherein
the line part is disposed between the first active electrode and the first passive electrode.

7. The antenna device according to claim 1, wherein
at least one of the first active electrode and the first passive electrode is laminated to the line part;
the line part includes lines disposed spaced apart at a pitch; and
a wavelength of an output signal of the high frequency voltage is larger than the pitch of the lines.

8. The antenna device according to claim 1, wherein
the external device further comprises:
a second active electrode configured to capacitively couple with the first active electrode;
a second passive electrode configured to capacitively couple with the first passive electrode, the second passive electrode being larger than the second active electrode; and
a load circuit configured to connect to the second active electrode and the second passive electrode, and to operate using a voltage induced between the second active electrode and the second passive electrode.

9. The antenna device according to claim 1, wherein
the antenna device is configured to mount on a roof, pillar, center console, or interior panel of a mobile object.

10. The antenna device according to claim 2, wherein
the line part is the first active electrode, or the line part is the first passive electrode.

11. The antenna device according to claim 2, wherein
the first active electrode or the first passive electrode is disposed at a periphery of the line part.

12. The antenna device according to claim 2, wherein
the line part is disposed between the first active electrode and the first passive electrode.

13. The antenna device according to claim 2, wherein
at least one of the first active electrode and the first passive electrode is laminated to the line part;
the line part includes lines disposed spaced apart at a pitch; and
a wavelength of an output signal of the high frequency voltage is larger than the pitch of the lines.

14. The antenna device according to claim 2, wherein
the external device further comprises:
a second active electrode configured to capacitively couple with the first active electrode;
a second passive electrode configured to capacitively couple with the first passive electrode, the second passive electrode being larger than the second active electrode; and
a load circuit configured to connect to the second active electrode and the second passive electrode, and to operate using a voltage induced between the second active electrode and the second passive electrode.

15. The antenna device according to claim 2, wherein
the antenna device is configured to mount on a roof, pillar, center console, or interior panel of a mobile object.

16. The antenna device according to claim 3, wherein
the line part is the first active electrode, or the line part is the first passive electrode.

17. The antenna device according to claim 3, wherein
the first active electrode or the first passive electrode is disposed at a periphery of the line part.

18. The antenna device according to claim 3, wherein
the line part is disposed between the first active electrode and the first passive electrode.

19. The antenna device according to claim 3, wherein
at least one of the first active electrode and the first passive electrode is laminated to the line part;
the line part includes lines disposed spaced apart at a pitch; and
a wavelength of an output signal of the high frequency voltage is larger than the pitch of the lines.

20. The antenna device according to claim 3, wherein
the external device further comprises:
a second active electrode configured to capacitively couple with the first active electrode;
a second passive electrode configured to capacitively couple with the first passive electrode, the second passive electrode being larger than the second active electrode; and
a load circuit configured to connect to the second active electrode and the second passive electrode, and to operate using a voltage induced between the second active electrode and the second passive electrode.

21. The antenna device according to claim 3, wherein
the antenna device is configured to mount on a roof, pillar, center console, or interior panel of a mobile object.
